(19) United States
(12) Patent Application Publication
(10) Pub. No.: US 2010/0123362 A1
(43) Pub. Date: May 20, 2010

(54) HYDROSTATIC BEARING PAD TYPE ROTATING DEVICE

(75) Inventor: Junichi Hirata, Iwata-shi (JP)

Correspondence Address: MCDERMOTT WILL & EMERY LLP, 600 13TH STREET, N.W., WASHINGTON, DC, 20005-3096, US

(73) Assignee: NTN CORPORATION

(21) Appl. No.: 12/606,653

(22) Filed: Oct. 27, 2009

(30) Foreign Application Priority Data
Nov. 18, 2008 (JP) 2008-294542

(51) Int. Cl. H02K 5/167; F16C 32/06

(52) U.S. Cl. 310/90; 384/107

(57) ABSTRACT

A hydrostatic bearing pad type rotating device includes: a stationary body; an axial pad and a radial pad each attached to the stationary body; a rotating body supported by the axial pad and the radial pad at least in the radial direction toward an axis thereof so as to be rotatable about the axis; and a motor for providing a driving force to rotate the rotating body. The motor includes a stator attached to the stationary body, and a rotor attached to the rotating body to be opposite to the stator with a gap interposed therebetween. At least one of the stator and the rotor is attached such that its location is adjustable in the radial direction toward the axis and the axial direction along the axis. In this way, a hydrostatic bearing pad type rotating device having highly precise rotation performance can be provided.

### BACKGROUND OF THE INVENTION

1. Field of the Invention

The present invention relates to a hydrostatic bearing pad type rotating device, in particular, to a hydrostatic bearing pad type rotating device having a motor.

2. Description of the Background Art

Traditionally, a rolling bearing has been used to support a large rotating body. Recently, in supporting such a large rotating body, a hydrostatic bearing pad for high-precision processing and precision measurement has been used to achieve reduced vibration, reduced noise, long life, and high speed rotation with high precision.

For example, a CT (computed tomography) scanner in the field of imaging for medical diagnostics has a large rotating body, which rotates with a radiation source and the like mounted thereon. A CT scanner employing a hydrostatic bearing pad is disclosed in, for example, Japanese National Patent Publication No. 2004-528113.

In the CT scanner described in the patent publication, a rotating gantry has an annular bearing race at its circumference. The bearing race of the rotating gantry is distant away from bearing pads mounted on a stationary gantry, with a layer of thin air therebetween. In this way, the rotating gantry is supported by the plurality of bearing pads from the stationary gantry.

Specifically, radial pads are provided on an outer polished circumferential surface of the bearing race. Axial pads are provided on proximal and distal flat circumferential surfaces of the bearing race.

The radial pads are fixed to the stationary gantry via radial ball studs. The axial pads are fixed via axial ball studs to a supporting arm attached to the stationary gantry. A spring element is provided between each pad and each ball stud.

The radial ball studs adjust the locations of the radial pads in the radial direction of the rotating body using the spring elements. On the other hand, the axial ball studs adjust the locations of the axial pads in the axial direction of the rotating body using the spring elements.

A large rotating body such as that in the above-described CT scanner is generally belt-driven by a motor external to the rotating device. However, in order to implement rotation with high-precision, ideally, a built-in motor should be incorporated into the rotating device to drive the rotating body directly.

Japanese Patent Laying-Open No. 2004-343921 discloses a configuration having a motor provided with a stator fixed to a stationary base of a computed tomography device using X rays and a rotor fixed to a rotating base. In other words, Japanese Patent Laying-Open No. 2004-343921 discloses that a built-in motor is incorporated into a rotating device to drive a rotating body directly. The rotating body of the device disclosed in Japanese Patent Laying-Open No. 2004-343921 is supported by a rolling bearing rather than a hydrostatic bearing pad. Hence, with the rotating body incorporated into the stationary body in the device disclosed in Japanese Patent Laying-Open No. 2004-343921, the location of the rotating body relative to the stationary body is determined according to the location at which the rolling bearing is provided as well as the dimension thereof, and is therefore always fixed. This secures an intended motor gap between the rotor and stator of the motor in the device disclosed in Japanese Patent Laying-Open No. 2004-343921.

In a rotating device supported by a hydrostatic bearing pad, the location of the bearing surface of each pad is determined by a location into which a ball stud is screwed, as in Japanese National Patent Publication No. 2004-528113. This determines a bearing clearance, which is a distance between each pad and the rotating body, as well as the location of the rotating body relative to the stationary body.

In order to form an optimum bearing clearance, the location of the bearing surface of each pad needs to be adjusted during assembling. Adjusting the location of the bearing surface of each pad causes fluctuation of a distance between the rotating body and the stationary body. This makes it difficult to simultaneously adjust the location of the rotating body relative to the stationary body to maintain it always at a fixed position.

Accordingly, even though the stator and rotor of the built-in motor are fixed to the rotating body and the stationary body at the predetermined locations and the rotating body is supported by the bearing pads as described in Japanese Patent Laying-Open No. 2004-343921, the motor gap between the rotor and the stator after assembling is less likely to be at a predetermined value. For this reason, utilization of a built-in motor is limited.

Further, if a disk-shaped bearing race portion and a cylindrical shaft portion are formed in one piece in a large rotating body, a large material therefor is required according to the outer shape of the disk-shaped bearing race portion. Such a large material is less likely to be available and results in increased material and processing costs.

In addition, if the disk-shaped bearing race portion and the cylindrical shaft portion are formed in one piece, it is difficult to process a surface of the bearing race with high precision. This results in decreased precision in rotation of the rotating device having them incorporated therein.

### SUMMARY OF THE INVENTION

The present invention is made in view of the foregoing problems, and has its object to provide a hydrostatic bearing pad type rotating device having highly precise rotation performance.

A hydrostatic bearing pad type rotating device of the present invention includes: a stationary body; a hydrostatic bearing pad attached to the stationary body; a rotating body supported by the hydrostatic bearing pad in at least a radial direction toward an axis thereof so as to be rotatable about the axis; and a motor for providing a driving force to rotate the rotating body. The motor includes: a stator attached to the stationary body, and a rotor attached to the rotating body to be opposite to the stator with a gap interposed therebetween. At least one of the stator and the rotor is attached such that its location is adjustable in the radial direction toward the axis.

The hydrostatic bearing pad type rotating device of the present invention provides a structure by which the location at which the stator is assembled can be adjusted and determined according to the rotor installed in the rotating body. Accordingly, an optimum bearing clearance and an optimum motor gap are achieved and the rotating body can be supported and driven without being contacted. In this way, highly precise rotation performance is achieved.

The hydrostatic bearing pad type rotating device described above preferably further includes an attachment member, provided in the stationary body, for adjusting the location of the stator in the radial direction toward the axis.

In the hydrostatic bearing pad type rotating device described above, preferably the attachment member has a plurality of screws provided to be screwed in at least one of the radial direction toward the axis and an axial direction along the axis, and the location and an angle of the stator are adjusted depending on an amount of screwing the screws.

In this way, depending on the amount of screwing the plurality of screws, the location and angle of the stator can be readily adjusted relative to the rotating body in the radial direction and the axial direction.

In the hydrostatic bearing pad type rotating device described above, the stator is preferably configured to be attachable/detachable using an inner diameter surface of the attachment member as a guide.

This facilitates operations in adjusting the rotor and the stator during assembling to achieve the optimum motor gap.

The hydrostatic bearing pad type rotating device described above preferably further includes an adjusting member, provided in the attachment member, for adjusting the location of the stator in an axial direction along the axis.

In this way, the location of the stator can be adjusted in the axial direction along the axis.

In the hydrostatic bearing pad type rotating device described above, the stationary body preferably includes a stator cover member, and each of the stator cover member and the attachment member has a material having high magnetic permeability.

This can prevent magnetism from leaking from the motor to its surroundings. Accordingly, the hydrostatic bearing pad type rotating device is prevented from being adversely effected by the magnetism leaked from the motor to its surroundings.

In the hydrostatic bearing pad type rotating device described above, the rotating body preferably has a configuration in which a cylindrical member constituting a radial bearing surface and a disk-shaped member constituting an axial bearing surface radially outwardly projecting toward the cylindrical member are fastened to each other.

Since the disk-shaped member forming the axial bearing and the cylindrical member forming the radial bearing are separate members as such, processing machines optimum for respective shapes thereof can be used upon finishing processing thereof. This allows improved precision in the bearing surfaces, resulting in improved precision in rotation of the bearings assembled. Accordingly, highly precise operation performance can be exhibited during operations. Further, a material therefor is smaller in dimension than that in the case where the rotating body is formed in one piece and processed, and is therefore readily available. In addition, costs for the material and processing are reduced.

In the hydrostatic bearing pad type rotating device described above, preferably the disk-shaped member is circumferentially divided into a plurality of parts.

In this way, the processing is facilitated and the material is readily available.

In the hydrostatic bearing pad type rotating device described above, the disk-shaped member is preferably formed of a material lower in density than that of the cylindrical member.

This achieves reduced weight and reduced inertia moment of the rotating body.

As described above, according to the hydrostatic bearing pad type rotating device of the present invention, while an optimum bearing clearance and an optimum motor gap are achieved, the rotating body can be supported and driven without being contacted. Highly precise rotation performance is achieved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic plan view of a hydrostatic bearing pad type rotating device of a first embodiment of the present invention.

FIG. 2 is a schematic cross sectional view of a portion thereof in the first embodiment of the present invention taken along a line II-II in FIG. 1.

FIG. 3 is an enlarged schematic cross sectional view showing a P portion shown in FIG. 2 in the first embodiment of the present invention.

FIG. 4 is an enlarged schematic cross sectional view showing a vicinity of a stator attachment member of a hydrostatic bearing pad type rotating device of a second embodiment of the present invention.

FIG. 5 is an enlarged schematic cross sectional view showing a vicinity of a stator attachment member of a hydrostatic bearing pad type rotating device of a third embodiment of the present invention.

FIG. 6 is an enlarged schematic cross sectional view showing a vicinity of a radial pad, a disk-shaped member, and a cylindrical member of a hydrostatic bearing pad type rotating device in a fourth embodiment of the present invention.

FIG. 7 is a plan view of the disk-shaped member of the hydrostatic bearing pad type rotating device in the fourth embodiment of the present invention.

FIG. 8 is a plan view of combined parts of disk-shaped member 1a fastened to cylindrical member 1b by screws in the fourth embodiment of the present invention.

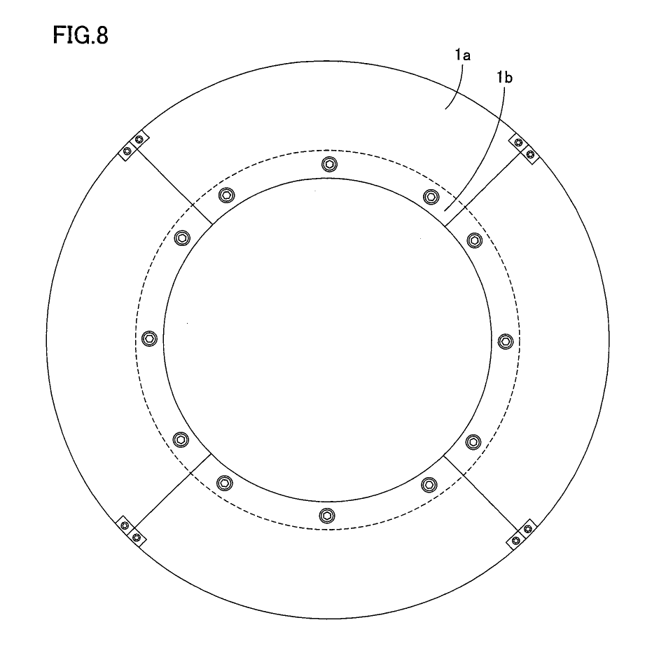

### DESCRIPTION OF THE PREFERRED EMBODIMENTS

Embodiments of the present invention will be described below with reference to figures.

### First Embodiment

A configuration of a hydrostatic bearing pad type rotating device of the present embodiment will be described first.

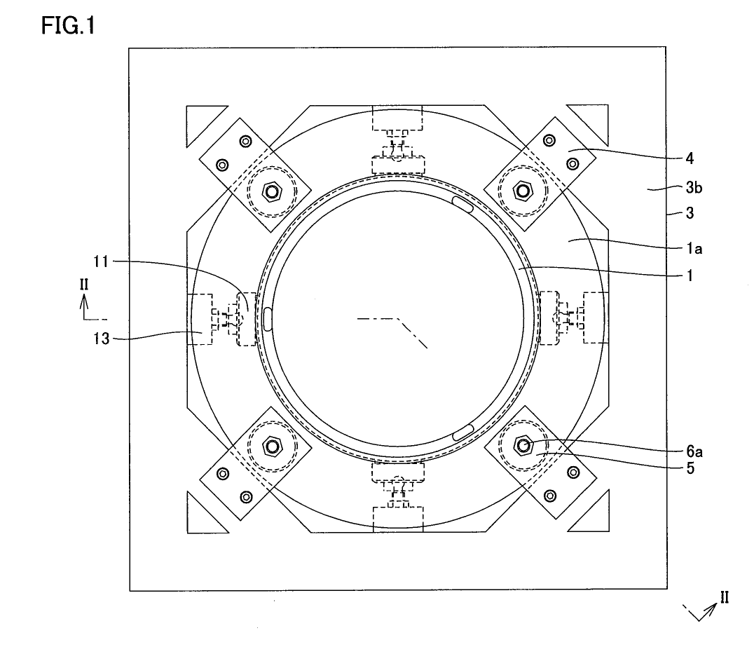

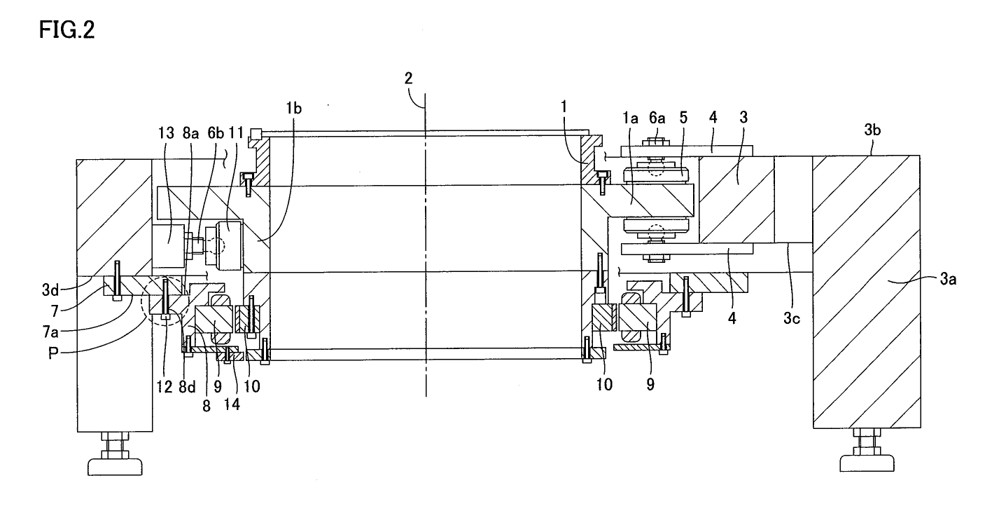

Referring to FIG. 1 and FIG. 2, the hydrostatic bearing pad type rotating device of the present embodiment mainly has a rotating body 1, a stationary body 3, an axial pad attachment plate 4, an axial pad 5, ball studs 6a, 6b, a stator base plate 7, a stator attachment member 8, a stator 9, a rotor 10, a radial pad 11, a pull bolt 12, a ball stud supporting member 13, and a stator cover member 14.

At the four corners of stationary body 3, supporting pillars 3a are provided to support stationary body 3. Stationary body 3 has a lower surface 3c parallel to its upper surface 3b and formed surrounded by supporting pillars 3a located at the four corners. To upper surface 3b and lower surface 3c, a plurality of axial pad attachment plates 4 are attached respectively. In the vicinity of the tip of each of axial pad attachment plates 4, a ball stud 6a is screwed. Axial pad 5 is supported by axial pad attachment plate 4 through ball stud 6a. From opposite sides through axial pad attachment plate 4, ball stud 6a determines the location of axial pad 5 toward an axial bearing portion.

Ball stud supporting member 13 is attached to stationary body 3 between supporting pillars 3a. Into ball stud supporting member 13, a ball stud 6b is screwed. Through ball stud 6b, radial pad 11 is supported by stationary body 3. Ball stud 6b determines the location of radial pad 11.

Rotating body 1 is provided within stationary body 3 to be rotatable about an imaginary axis 2 of rotating body 1. Rotating body 1 has a disk-shaped member 1a forming the axial bearing portion projecting radially outwardly, and a cylindrical member 1b located below it and forming a radial bearing portion. Rotating body 1 is supported by radial pad 11 and axial pads 5 each serving as a hydrostatic bearing pad. In other words, rotating body 1 is supported by radial pad 11 in the radial direction toward axis 2 of rotating body 1, whereas rotating body 1 is supported in the axial direction by axial pad 5.

Rotating body 1 is configured to be rotatable when supplied with a driving force from a motor. The motor has a stator 9 and a rotor 10. Stator 9 and rotor 10 are disposed with a gap interposed therebetween.

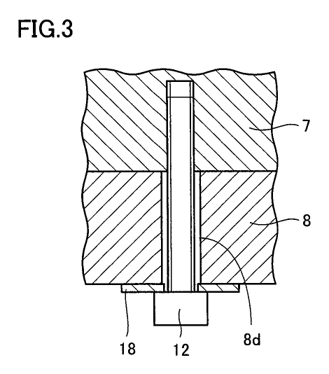

Rotor 10 is attached to cylindrical member 1b of rotating body 1 at its lower portion via a bolt. Between supporting pillars 3a of the stationary body, a lower end surface 3d parallel to upper surface 3b is provided. Stator base plate 7 is attached to lower end surface 3d via a bolt. Stator base plate 7 has a lower portion surface 7a to which stator attachment member 8 is attached by pull bolt 12 using a washer 18 (see FIG. 3). Stator 9 is inserted into and fixed in stator attachment member 8 in a direction opposite to rotating body 1. Referring to FIG. 3, stator attachment member 8 has an attaching bolt hole 8d having a diameter larger than the outer diameter of pull bolt 12. The outer diameter of pull bolt 12 is, for example, 8 mm. Meanwhile, the diameter of attaching bolt hole 8d is, for example, 10 mm. A clearance between attaching bolt hole 8d and pull bolt 12 is almost as large as the gap between stator 9 and rotor 10 of the motor.

Accordingly, stator 9 attached to stator attachment member 8 can be moved into a plane along lower portion surface 7a of stator base plate 7. Thus, when attaching stator attachment member 8 to stator base plate 7, the location of stator attachment member 8 in the horizontal plane is adjusted and fixed to achieve an optimum gap between stator 9 and rotor 10.

Next, functions and effects of the hydrostatic bearing pad type rotating device of the present embodiment will be described.

According to the hydrostatic bearing pad type rotating device of the present embodiment, while there is provided an optimum bearing clearance between rotating body 1 and each of radial pad 11 and axial pad 5, the location of stator 9 can be readily adjusted to secure an optimum motor gap between stator 9 and rotor 10 incorporated into rotating body 1. As such, a built-in motor, which implements rotation with high precision, can be readily incorporated into the hydrostatic bearing pad type rotating device of the present embodiment. While the optimum bearing clearance and the optimum motor gap are secured, rotating body 1 is supported and driven without being contacted, thus achieving highly precise rotation performance.

### Second Embodiment

A configuration of a hydrostatic bearing pad type rotating device of the present embodiment will be described first.

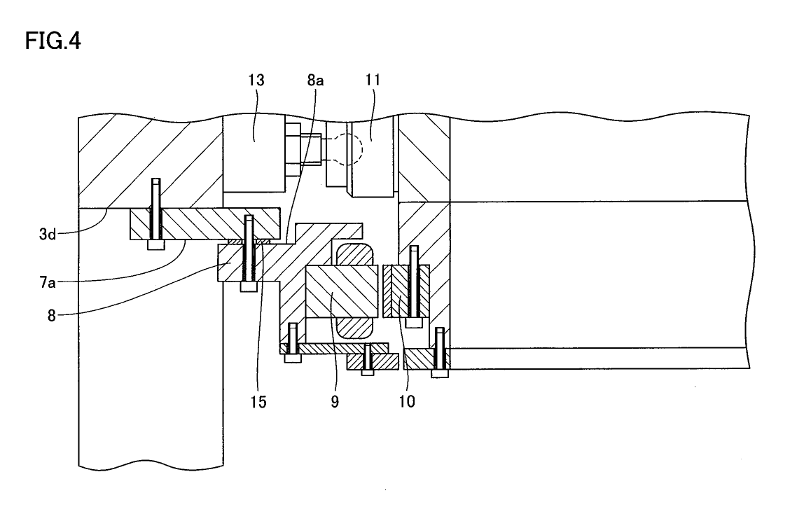

Referring to FIG. 4, the hydrostatic bearing pad type rotating device of the present embodiment is mainly different from the configuration of the first embodiment in that it includes an adjusting member 15.

Adjusting member 15 is disposed on an upper end surface 8a of stator attachment member 8 in a clearance between stator base plate 7 supported by stationary body 3 and stator attachment member 8.

With this, stator 9 can be moved in the axial direction along axis 2. Thus, the location of stator 9 can be adjusted in the axial direction along axis 2.

It should be noted that other configurations in the present embodiment are similar to those of the foregoing first embodiment, and the same elements are therefore given the same reference characters and will not be described repeatedly.

Next, functions and effects of the hydrostatic bearing pad type rotating device of the present embodiment will be described.

According to the hydrostatic bearing pad type rotating device of the present embodiment, adjusting member 15 is disposed between lower portion surface 7a of stator base plate 7 and upper end surface 8a of stator attachment member 8, whereby the location of stator 9 can be adjusted in the axial direction along axis 2.

Accordingly, also in the axial direction, with the motor gap being optimum, rotating body 1 is supported and driven without being contacted, thus achieving highly precise rotation performance.

### Third Embodiment

A configuration of a hydrostatic bearing pad type rotating device of the present embodiment will be described first.

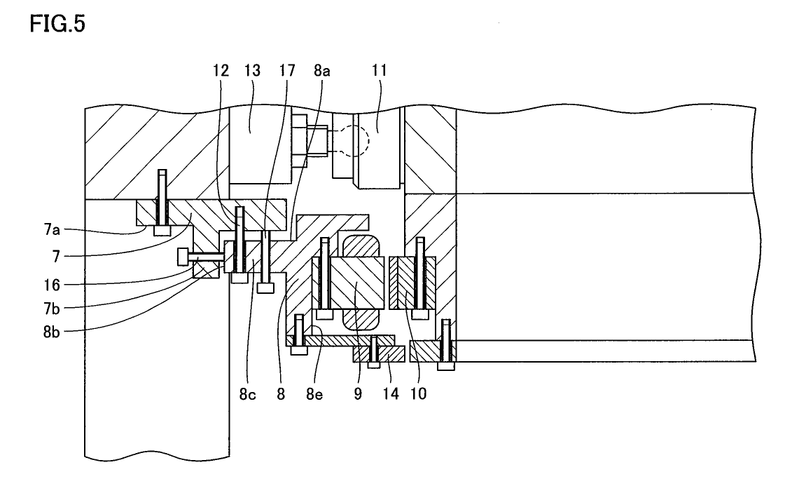

Referring to FIG. 5, the hydrostatic bearing pad type rotating device of the present embodiment is mainly different from the configuration of the first embodiment, in respective shapes of stator base plate 7 and stator attachment member 8 as well as in that it has adjusting bolts 16 and push bolts 17. Another difference mainly lies in that stator 9 is configured to be attachable/detachable using an inner diameter surface 8e of stator attachment member 8 as a guide.

Explained first are the respective shapes of stator base plate 7 and stator attachment member 8 as well as adjusting bolt 16 and push bolt 17 provided in the hydrostatic bearing pad type rotating device of the present embodiment.

Stator base plate 7 has lower portion surface 7a at the central portion of which a projection 7b having a circular circumference is formed. Projection 7b is provided with screw holes, via which the plurality of adjusting bolts 16 are screwed inwardly toward an outer circumferential end surface 8b of stator attachment member 8. Further, stator attachment member 8 has an outer circumferential surface portion 8c, in which the plurality of pull bolts 12 and push bolts 17 are disposed. The plurality of pull bolts 12 and push bolts 17 are screwed toward stator base plate 7. Specifically, the plurality of adjusting bolts 16 are screwed in the radial direction toward axis 2, whereas the plurality of pull bolts 12 and push bolts 17 are screwed in the axial direction along axis 2.

In this way, the location and angle of stator attachment member 8 can be readily changed relative to stator base plate 7 in the radial direction and axial direction of rotating body 1. Accordingly, the location and angle of stator 9 attached to stator attachment member 8 can be readily adjusted in the radial direction and axial direction of rotating body 1.

Explained next is the difference in that stator 9 is configured to be attachable/detachable using inner diameter surface 8e of stator attachment member 8 as a guide.

In general, a rotating device employs a servomotor to achieve rotation with high precision. The motor in the present embodiment employs a permanent magnet. Accordingly, if rotor 10 and stator 9 are fixed to rotating body 1 or stationary body 3 from the beginning, rotor 10 and stator 9 are stuck to each other, which makes operations very difficult during adjustment in assembling.

In view of this, the location of inner diameter surface 8e for attachment of the stator is first adjusted relative to rotor 10 fixed to rotating body 1. Thereafter, stator 9, which is manufactured to have precise coaxiality in its outer and inner diameters, is inserted into inner diameter surface 8e for attachment of the stator. Then, stator 9 is fixed to stator attachment member 8 by a bolt or the like.

With this, stator 9 is attached/detached using inner diameter surface 8e for attachment of the stator as a guide.

It should be noted that other configurations of the present embodiment are similar to those of the foregoing first embodiment, and the same elements are given the same reference characters and will not be described repeatedly.

Next, functions and effects of the hydrostatic bearing pad type rotating device of the present embodiment will be described.

According to the hydrostatic bearing pad type rotating device of the present embodiment, depending on an amount of screwing adjusting bolts 16, pull bolts 12, and push bolts 17 provided as described above, the location and angle of stator 9 can be readily adjusted relative to rotating body 1 in the radial direction and the axial direction.

In addition, since stator 9 is configured to be attachable/detachable using inner diameter surface 8e of stator attachment member 8 as a guide, operations are facilitated when rotor 10 and stator 9 are adjusted during assembling to achieve an optimum motor gap.

In this way, with the motor gap being optimum, rotating body 1 is supported and driven without being contacted, thus achieving highly precise rotation performance.

### Fourth Embodiment

A configuration of a hydrostatic bearing pad type rotating device of the present embodiment will be described first.

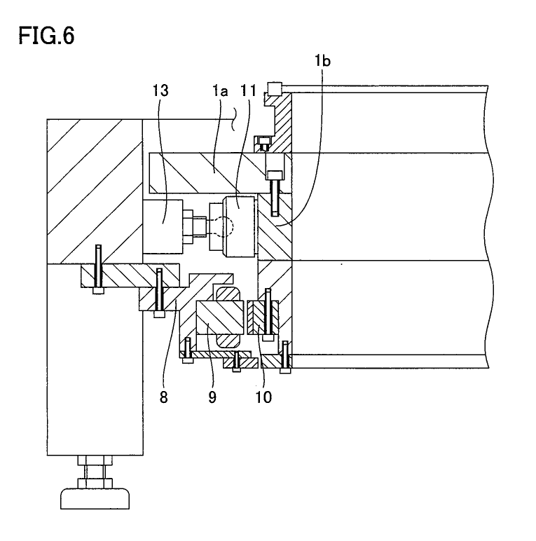

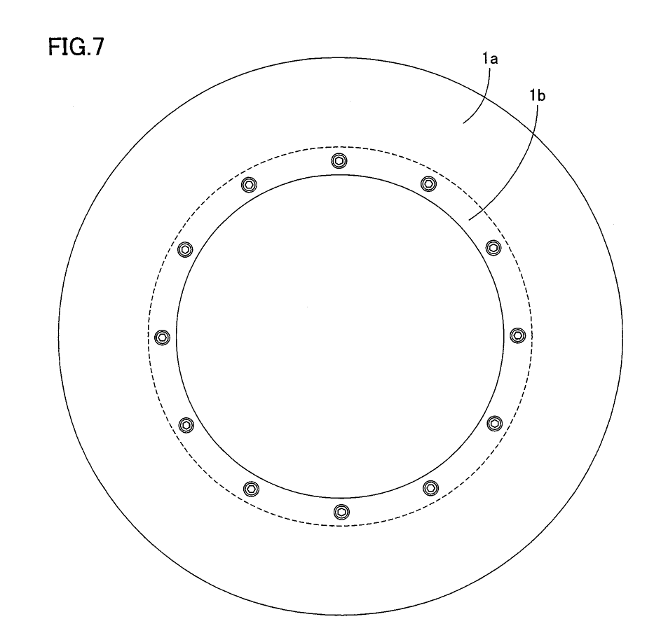

Referring to FIG. 6 and FIG. 7, the hydrostatic bearing pad type rotating device of the present embodiment is mainly different from the configuration of the first embodiment in that disk-shaped member 1a constituting the axial bearing surface and cylindrical member 1b constituting radial bearing surface are separate members.

Disk-shaped member 1a and cylindrical member 1b are processed and formed as separate members. After each portion of disk-shaped member 1a and cylindrical member 1b is subjected to finishing processing, they are fastened to each other by a bolt or the like.

It should be noted that other configurations of the present embodiment are similar to those of the foregoing first embodiment, and the same elements are given the same reference characters and will not be described repeatedly.

Next, functions and effects of the hydrostatic bearing pad type rotating device of the present embodiment will be described.

According to the hydrostatic bearing pad type rotating device of the present embodiment, disk-shaped member 1a serving as the axial bearing portion and cylindrical member 1b serving as the radial bearing portion can be processed separately. Hence, processing machines suitable for the shapes thereof can be selected. This allows for improved precision in processing individual bearing surfaces, whereby highly precise rotation performance can be exhibited while being operated.

In addition, materials used therefor are small in dimension, and are therefore readily available.

In the present embodiment, a material lower in density than that for cylindrical member 1b may be used for disk-shaped member 1a, which has a large outer shape. This achieves reduced weight and reduced inertia moment of rotating body 1.

Furthermore, in the present embodiment, to manufacture disk-shaped member 1a, a plurality of divided parts thereof may be used. The divided parts of disk-shaped member 1a may be combined together and fastened to cylindrical member 1b by screws or the like to form rotating body 1.

By forming disk-shaped member 1a as described above, processing is facilitated and the material therefor is readily available.

Stator attachment member 8 and stator cover member 14 in the hydrostatic bearing pad type rotating device of the present invention may be formed of a material having magnetic permeability, in the case where magnetism is leaked from the motor to its surroundings to adversely effect the hydrostatic bearing pad type rotating device.

Employed as the material having magnetic permeability can be, for example, a material having a large magnetic permeability such as permalloy or sendust, or a material having a high saturation flux density such as a silicon steel plate.

This can prevent magnetism from leaking from the motor to its surroundings. In this way, the hydrostatic bearing pad type rotating device can be prevented from being adversely effected by magnetism leaked from the motor to its surroundings.

It should be noted that the above description deals with the hydrostatic bearing pad type rotating device allowing for adjustment of the location of the stator, but the present invention is not limited to this. The present invention is applicable to a hydrostatic bearing pad type rotating device allowing for adjustment of the location of the rotor in both the axial direction and the radial direction, as is the case with the stator.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A hydrostatic bearing pad type rotating device comprising:
a stationary body;
a hydrostatic bearing pad attached to said stationary body;
a rotating body supported by said hydrostatic bearing pad in at least a radial direction toward an axis thereof so as to be rotatable about said axis; and
a motor for providing a driving force to rotate said rotating body,
said motor including:
a stator attached to said stationary body; and
a rotor attached to said rotating body to be opposite to said stator with a gap interposed therebetween,
at least one of said stator and said rotor being attached such that its location is adjustable in the radial direction toward said axis.

2. The hydrostatic bearing pad type rotating device according to claim 1, further comprising an attachment member, provided in said stationary body, for adjusting the location of said stator in the radial direction toward said axis.

3. The hydrostatic bearing pad type rotating device according to claim 2, wherein said attachment member has a plurality of screws provided to be screwed in at least one of the radial direction toward said axis and an axial direction along said axis, and the location and an angle of said stator are adjusted depending on an amount of screwing said screws.

4. The hydrostatic bearing pad type rotating device according to claim 2, wherein said stator is configured to be attachable/detachable using an inner diameter surface of said attachment member as a guide.

5. The hydrostatic bearing pad type rotating device according to claim 2, further comprising an adjusting member, provided in said attachment member, for adjusting the location of said stator in an axial direction along said axis.

6. The hydrostatic bearing pad type rotating device according to claim 2, wherein said stationary body includes a stator cover member, and each of said stator cover member and said attachment member has a material having high magnetic permeability.

7. The hydrostatic bearing pad type rotating device according to claim 1, wherein said rotating body has a configuration in which a cylindrical member constituting a radial bearing surface and a disk-shaped member constituting an axial bearing surface radially outwardly projecting toward said cylindrical member are fastened to each other.

8. The hydrostatic bearing pad type rotating device according to claim 7, wherein said disk-shaped member is circumferentially divided into a plurality of parts.

9. The hydrostatic bearing pad type rotating device according to claim 7, wherein said disk-shaped member is formed of a material lower in density than that of said cylindrical member.
